(19) United States
(12) Patent Application Publication
(10) Pub. No.: US 2026/0085970 A1
(43) Pub. Date: Mar. 26, 2026

(54) MULTIPLE-OPTICAL-AXIS PHOTOELECTRIC SENSOR

(71) Applicant: Keyence Corporation, Osaka (JP)

(72) Inventors: Daiki MATSUMOTO, Osaka (JP); Tatsuki ASUKA, Osaka (JP); Yuga ASANO, Osaka (JP)

(73) Assignee: Keyence Corporation, Osaka (JP)

(21) Appl. No.: 19/294,390

(22) Filed: Aug. 8, 2025

(30) Foreign Application Priority Data
Sep. 24, 2024 (JP) 2024-165355

(51) Int. Cl. G01J 1/04; G01J 1/02

(52) U.S. Cl. CPC G01J 1/0407; G01J 1/0271

(57) ABSTRACT

A size of a light curtain is reduced while function expansibility is maintained. A multiple-optical-axis photoelectric sensor includes a light curtain that forms a plurality of optical axes along a longitudinal direction, and a function expansion unit that is attachable to or detachable from a first end of the light curtain and expands a function of the light curtain. The function expansion unit has a protrusion that extends along the longitudinal direction and is attached to the first end of the light curtain so as to protrude from an outer peripheral surface of the light curtain.

### CROSS-REFERENCE TO RELATED APPLICATIONS

The present application claims foreign priority based on Japanese Patent Application No. 2024-165355, filed Sep. 24, 2024, the contents of which are incorporated herein by reference.

### BACKGROUND OF THE INVENTION

### 1. Technical Field

The invention relates to a multiple-optical-axis photoelectric sensor.

### 2. Description of the Related Art

A light curtain is an aspect of a multiple-optical-axis photoelectric sensor. The light curtain detects a person or an object depending on whether or not a plurality of optical axes formed between a light projector and a light receiver are shielded.

Some light curtains of related art include an operation indicator lamp at an uppermost portion thereof (see, for example, JP2002-124169A). For example, the operation indicator lamp is turned off in a case where light beams from light projecting elements are received by all light receiving elements, and is turned on in other cases. In addition, the turned-on state of the operation indicator lamp can change even when an error occurs.

In addition, some light curtains of the related art have a function expansion unit attachable to or detachable from the uppermost portion thereof.

In addition to the operation indicator lamp described above, a connector cable or the like for connecting other light curtains in series can be attached or detached as the function expansion unit.

Incidentally, the light curtain of the related art having function expandability is designed such that a function expansion unit does not protrude from an outer peripheral surface thereof, particularly, a surface facing a base to which the light curtain is attached. This is because, when a gap formed between the outer peripheral surface of the light curtain and the base is large in a work of attaching the light curtain, the worker's fingers or hands may enter the gap, which may impair safety.

However, many function expansion units have a thickness of 5 to 10 mm in order to secure a storage space for cables, substrates, or the like. Accordingly, it is necessary to secure a surplus space in a housing of the light curtain by at least the above-described thickness. Thus, the light curtain having the function expandability is limited in size reduction of the housing, and tends to be larger than a light curtain not having function expandability.

### SUMMARY OF THE INVENTION

In view of the above problems, an object of the invention is to reduce a size of a light curtain while function expansibility is maintained.

A multiple-optical-axis photoelectric sensor according to the invention is a multiple-optical-axis photoelectric sensor including, for example, a light curtain that forms a plurality of optical axes along a longitudinal direction, and a function expansion unit that is attachable to or detachable from a first end of the light curtain and expands a function of the light curtain. The function expansion unit has a protrusion that extends along the longitudinal direction and is attached to the first end of the light curtain so as to protrude from an outer peripheral surface of the light curtain.

Note that, other characteristics, elements, steps, advantages, and features will be more apparent from the following detailed description and the accompanying drawings.

According to the invention, the function expansion unit is allowed to protrude from the outer peripheral surface of the light curtain, and thus, it is possible to minimize the light curtain when the function expansion unit is not attached. Accordingly, it is possible to reduce the size of the light curtain while function expansibility is maintained.

### BRIEF DESCRIPTION OF THE DRAWINGS

FIG. 1 is a diagram illustrating a schematic configuration of a light curtain;

FIG. 2 is a perspective view illustrating an overall configuration of a light projector;

FIG. 3 is a front view illustrating an overall configuration of the light projector;

FIG. 4 is a perspective view illustrating one end of the light projector;

FIG. 5 is a functional block diagram of the light curtain;

FIG. 6 is a diagram illustrating a first embodiment of the light projector;

FIG. 7 is a diagram illustrating an arrangement example of indicator lamp light sources according to the first embodiment;

FIG. 8 is an old and new comparison diagram illustrating a relationship between presence or absence of function expansion and an attachment tool;

FIG. 9 is a diagram illustrating the relationship between the presence or absence of function expansion and a size in a thickness direction;

FIG. 10 is a diagram illustrating an attachment mechanism of an end cap;

FIG. 11 is an old and new comparison diagram of a cable connection structure;

FIG. 12 is a sectional view illustrating an example of direct draw type cable connection;

FIG. 13 is a sectional view illustrating an example of a fixing structure between a metal case and the end cap;

FIG. 14 is a diagram illustrating a bottom surface of a housing, and an α-α section and a β-β section;

FIG. 15 is a diagram illustrating a configuration example of an AC discharge unit;

FIG. 16 is a diagram illustrating a configuration example of a conductive member; and

FIG. 17 is a sectional view illustrating an outer shape of the housing.

### DETAILED DESCRIPTION

### <Light Curtain>

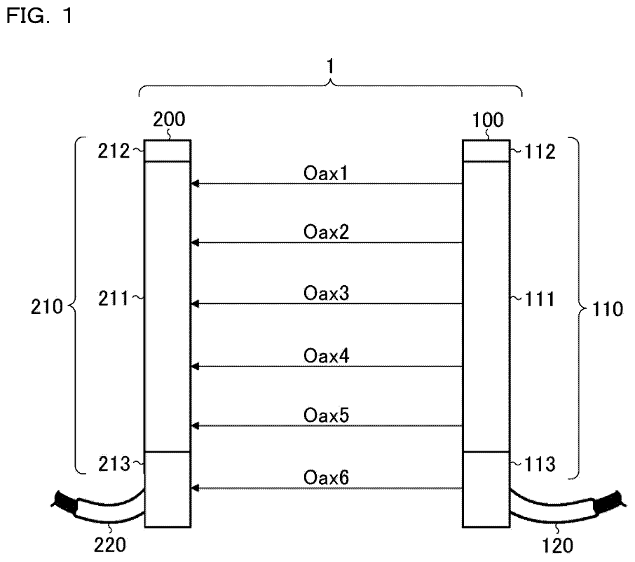

FIG. 1 is a diagram illustrating a schematic configuration of a light curtain. The light curtain 1 of the present configuration example is an aspect of a multiple-optical-axis photoelectric sensor, and generally includes a pair of a light projector 100 and a light receiver 200.

The light curtain 1 detects a person or an object depending on whether or not at least one of a plurality of optical axes (six optical axes Oax1 to Oax6 in this drawing) formed at intervals from each other between the light projector 100 and the light receiver 200 arranged in parallel is shielded. For example, the light curtain 1 is provided at an entrance or the like of a dangerous region where a dangerous source such as a press machine is placed, and can be used as a safety device for detecting intrusion or presence of a worker.

The light projector 100 and the light receiver 200, respectively, include elongated (up to 2 m or more) housings 110 and 210 and cables 120 and 220 connected thereto.

The housing 110 includes a hollow metal case 111 extending in a longitudinal direction, and hollow end caps 112 and 113 (corresponding to end members) connected to both ends of the metal case 111, respectively. Similarly, the housing 210 includes a hollow metal case 211 extending in a longitudinal direction, and hollow end caps 212 and 213 (corresponding to end members) connected to both ends of the metal case 211, respectively. In the present embodiment, the longitudinal direction is a direction substantially parallel to a direction in which the plurality of optical axes formed between the light projector 100 and the light receiver 200 are arranged at intervals.

As described above, when the metal cases 111 and 211 having high rigidity are adopted as the cases of the housings 110 and 210, the elongated housings 110 and 210 are less likely to be deformed. Accordingly, arrangement adjustment (for example, angle adjustment for arranging both housings in parallel) of the light projector 100 and the light receiver 200 becomes relatively easy. Note that, for example, an inexpensive and lightweight aluminum extrusion-molded product may be used as the metal cases 111 and 211. In this case, the metal cases 111 and 211 all have the same section regardless of where the metal cases are cut in an extrusion direction (=longitudinal direction).

Each of the end caps 112, 113, 212, and 213 may be formed by injection molding by using a resin material, or may be formed by die casting by using a metal material such as zinc. Note that, interfaces with the cables 120 and 220 can be mounted on the end caps 113 and 213 on a lower side of this drawing. Thus, the end caps 113 and 213 may be larger than the end caps 112 and 212 on an upper side of this drawing.

### <Light Projector>

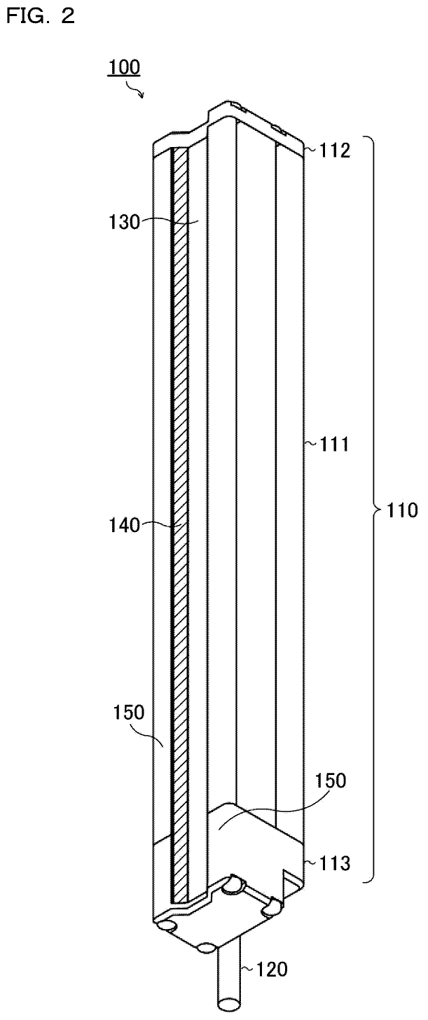

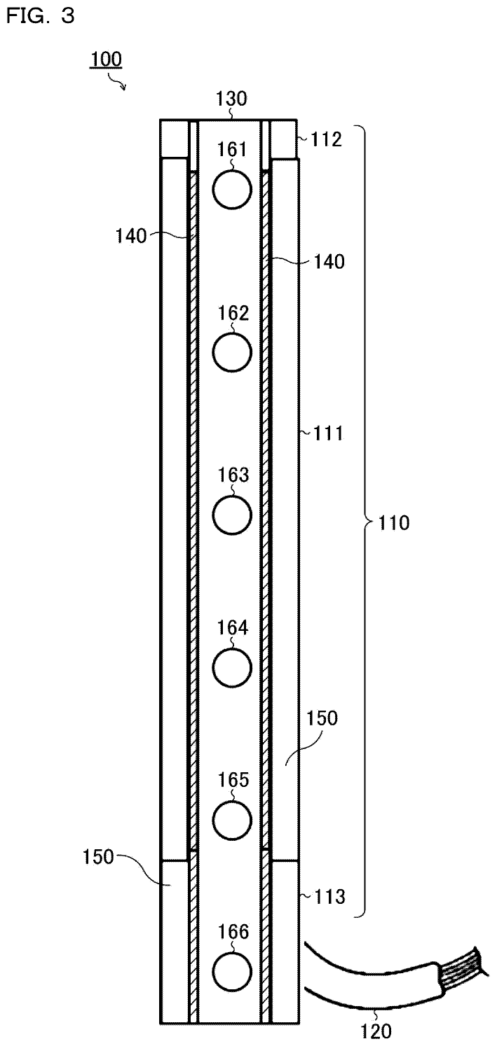

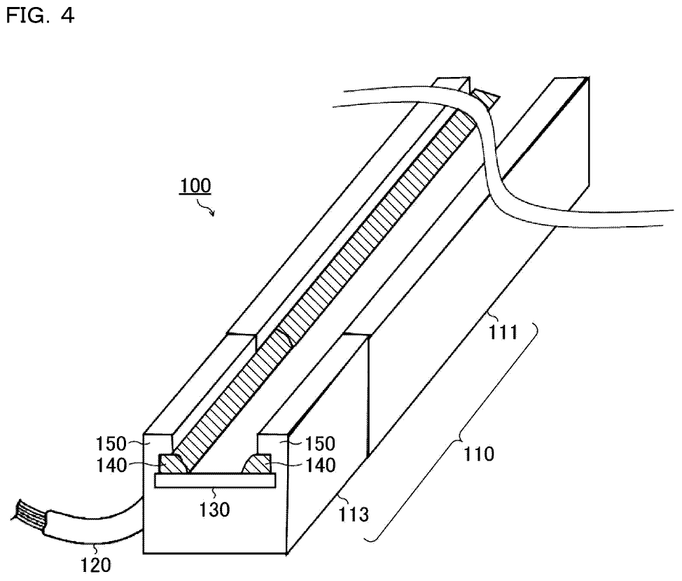

FIGS. 2 and 3 are a perspective view and a front view, respectively, illustrating an overall configuration of the light projector 100. In addition, FIG. 4 is a perspective view illustrating one end of the light projector 100.

As described above, the light projector 100 includes the housing 110 and the cable 120. In addition, the housing 110 includes the metal case 111 and the end caps 112 and 113. Further, the light projector 100 includes a front cover 130, indicator lamps 140, and bumpers 150.

The front cover 130 is an elongated light transmission plate attached to cover a front opening (=detection window) of the housing 110. In the front opening of the housing 110, light projecting elements 161 to 166 for forming the plurality of optical axes Oax1 to Oax6 are arranged at equal intervals along a longitudinal direction. That is, the front cover 130 is attached to the housing 110 so as to cross the plurality of optical axes Oax1 to Oax6. The front cover 130 may be a light-transmissive resin plate (acrylic plate or the like) extrusion-molded or may be a glass plate. The light-transmissive properties of the member used as the front cover 130 in the present embodiment refer to light-transmissive properties to the extent that light beams of the light projecting elements 161 to 166 forming the plurality of optical axes Oax1 to Oax6 are not excessively diffused out of the optical axes and are received by light receiving elements 261 to 266 to be described later with a certain light amount or more. As described above, since the light-transmissive member is used for the front cover 130, a worker can visually recognize the light projecting elements 161 to 166 through the front cover 130.

Note that, the light projecting element (the light projecting element 166 in FIG. 3) corresponding to at least one optical axis among the plurality of optical axes Oax1 to Oax6 may be arranged in the end cap 113. That is, the light projecting elements 161 to 166 may be arranged at equal intervals in the longitudinal direction over the entire region from one end to the other end of the light projector 100. In addition, the cable 120 may extend from a back surface (or side surface) of the end cap 113 instead of extending from a lower surface of the end cap 113. With such a configuration, the light projector 100 can be installed close to an installation surface (floor surface or the like). Accordingly, dead space-less can be realized.

The indicator lamps 140 are controlled to be turned on or off with a light emission color corresponding to, for example, an operation state of the light curtain 1 (an optical-axis detection state, a self-diagnosis result, or the like) or a work instruction regarding putting in and taking out an object. That is, the indicator lamp 140 functions as an operation indicator lamp or a work instruction lamp. Accordingly, the worker can visually recognize the operation state or the work instruction of the light curtain 1 by looking at the indicator lamps 140 of the light curtain 1.

In particular, the indicator lamps 140 are arranged outward from an outer surface of at least one of the front cover 130 and the housing 110 along a longitudinal direction, or are formed in series with the front cover 130 (details of a structure will be described later). With reference to this drawing, the indicator lamps 140 are provided on both sides of the front cover 130. With the indicator lamps 140 arranged or formed in this manner, it is possible to perform highly visible display without impairing the rigidity of the housing 110. More specifically, the indicator lamp 140 is an elongated extrusion-molded product, and is arranged such that the longitudinal direction of the indicator lamp 140 is along the longitudinal direction of the housing 110. Note that, the indicator lamps 140 may be arranged along the longitudinal direction of the housing 110, and a manufacturing method therefor is not limited to extrusion-molding, and a shape of the indicator lamp 140 may not be the elongated shape. For example, a plurality of members functioning as the indicator lamps 140 may be arranged along the longitudinal direction of the housing 110.

In addition, the indicator lamp 140 is a light diffusing member that diffuses light incident from an indicator lamp light source 170 (not illustrated) accommodated inside the housing 110 in various directions. More specifically, the indicator lamp 140 contains a light diffusing body that diffuses light in various directions. In the configuration in which the light diffusing member as the indicator lamp 140 contains the light diffusing body, even in a case where the number of indicator lamp light sources 170 is small with respect to a size of a surface of the indicator lamp 140, since the indicator lamp 140 can be relatively uniformly illuminated, highly visible display can be performed. In the present embodiment, the indicator lamp 140 is milky white because the indicator lamp is made of a transparent resin to which fine particles are added. In a case where a base resin is not transparent but has a specific color, the specific color and milky white are mixed. In a case where the indicator lamp 140 is made of a milky white resin (silicone or the like) in addition to the configuration in which the light diffusing member contains the light diffusing body, it is possible to obtain an action of relatively uniformly illuminating the indicator lamp 140. The light diffusing member as the indicator lamp 140 may be a member that diffuses the light from the indicator lamp light source 170 such that the light can be visually recognized from more directions, or a member that diffuses the light from the indicator lamp light source 170 to such an extent that it is difficult to visually recognize a contour of the indicator lamp light source 170 from an outside of the indicator lamp 140. For example, a light diffusing member having a surface machined to diffuse the light from the indicator lamp light source 170 may be arranged as the indicator lamp 140. For example, emboss machining is known as surface machining for diffusing light. With the configuration in which the light diffusing member having the machined surface is arranged as the indicator lamp 140, in a case where a region in which light is relatively easily diffused and a region in which light is relatively less easily diffused are provided in one member, it is easy to manufacture such a member.

The bumpers 150 protrude outward from a region, of the outer surface of the front cover 130, which crosses the plurality of optical axes Oax1 to Oax6, and are arranged along the longitudinal direction of the housing 110 (details of a structure will be described later).

With reference to this drawing, a pair of bumpers 150 is formed so as to protrude from both sides of the front cover 130. That is, the front cover 130 is disposed in a narrow valley sandwiched between the pair of bumpers 150 (twin bumpers proposed by the applicant of the present application) positioned on both sides thereof and protruding forward. Thus, even though the object collides with a front surface of the light projector 100, the impact thereof is received by the bumpers 150. Accordingly, the front cover 130 is less likely to be damaged. Note that, the bumper 150 may be made of a hard material such as metal.

In addition, a configuration of the light receiver 200 is basically similar to a configuration of the light projector 100. Accordingly, in the description of FIGS. 2 to 4, the configuration of the light receiver 200 can be understood by appropriately reading the light projector 100 and the light projecting elements 161 to 166 with the light receiver 200 and the light receiving elements 261 to 266, respectively, and appropriately replacing reference numerals in other 100 series with reference numerals in 200 series. In addition, the same applies to the following description.

### <Functional Block>

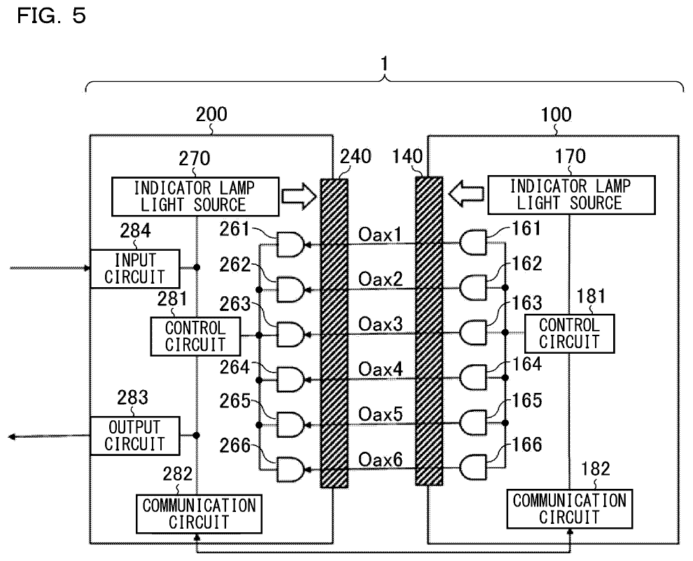

FIG. 5 is a functional block diagram of the light curtain 1. In the light curtain 1 of the present configuration example, the light projector 100 includes the indicator lamps 140, the light projecting elements 161 to 166, the indicator lamp light source 170, a control circuit 181, and a communication circuit 182.

The light projecting elements 161 to 166 are arranged at equal intervals at a predetermined pitch along the longitudinal direction of the light projector 100. The light projecting elements 161 to 166 sequentially project a plurality of light beams for, respectively, forming the plurality of optical axes Oax1 to Oax6 toward the light receiver 200 (in particular, the light receiving elements 261 to 266) in a time division manner based on a light projection control signal input from the control circuit 181. Note that, the light projecting elements 161 to 166 may be, for example, light emitting diodes that emit infrared light beams.

The indicator lamp light source 170 supplies light for display toward the indicator lamps 140 based on a display control signal input from the control circuit 181. The indicator lamp light source 170 may be switchable between a plurality of light emission colors (for example, red, green, and orange) in accordance with the operation state of the light curtain 1, the work instruction, or the like.

Note that, the indicator lamp light source 170 may be pulse-turned on at a timing temporally offset from a light projection or light reception timing of each of the plurality of optical axes Oax1 to Oax6. According to such turned-on or turned-off control, interference with the optical-axis detection by the indicator lamp light source 170 can be suppressed.

The indicator lamp 140 diffuses light incident from the indicator lamp light source 170 in various directions. The worker can visually recognize the operation state of the light curtain 1, the work instruction, or the like by looking at the indicator lamps 140.

In response to an instruction from the light receiver 200, the control circuit 181 generates the light projection control signal so as to sequentially drive the light projecting elements 161 to 166 in a time division manner. In addition, the control circuit 181 generates the display control signal so as to turn on or off the indicator lamp light source 170 in any light emission color. Further, the control circuit 181 exchanges various types of information with the communication circuit 182.

The communication circuit 182 performs wired or wireless communication with the light receiver 200 (in particular, the communication circuit 282). For example, the communication circuit 182 receives an input of information regarding the operation state (an optical-axis detection state, a self-diagnosis result, and the like) of the light curtain 1 from the light receiver 200 and transmits the information to the control circuit 181.

On the other hand, the light receiver 200 includes an indicator lamp 240, light receiving elements 261 to 266, an indicator lamp light source 270, a control circuit 281, a communication circuit 282, an output circuit 283, and an input circuit 284.

The light receiving elements 261 to 266 are arranged at equal intervals at the same pitch as the light projecting elements 161 to 166 along the longitudinal direction of the light receiver 200. The light receiving elements 261 to 266 sequentially receive a plurality of light beams for forming the plurality of optical axes Oax1 to Oax6 in a time division manner based on a light reception control signal input from the control circuit 281. Note that, the light receiving elements 261 to 266 may be, for example, photodiodes or phototransistors that output electric signals corresponding to a light reception amount of infrared light.

The indicator lamp light source 270 supplies light for display toward the indicator lamp 240 based on a display control signal input from the control circuit 281. Similarly to the indicator lamp light source 170, the indicator lamp light source 270 may be switchable between a plurality of light emission colors (for example, red, green, and orange) in accordance with the operation state of the light curtain 1, the work instruction, or the like.

Note that, the indicator lamp light source 270 may be pulse-turned on at a timing temporally offset from the light projection or light reception timing of each of the plurality of optical axes Oax1 to Oax6. According to such turned-on or turned-off control, interference with the optical-axis detection by the indicator lamp light source 270 can be suppressed.

In addition, a case where the indicator lamp light source 270 is continuously turned on will be considered. In this case, it is desirable that a saturation prevention circuit (=a subtraction circuit for a DC component) is provided such that the electric signals output from the light receiving elements 261 to 266 are not saturated even though direct-current light from the indicator lamp light source 270 is received by the light receiving elements 261 to 266.

The indicator lamp 240 diffuses light incident from the indicator lamp light source 270 in various directions. The worker can visually recognize the operation state of the light curtain 1, the work instruction, or the like by looking at the indicator lamp 240.

In addition, since the indicator lamps 140 and 240 are provided on both the light projector 100 and the light receiver 200, respectively, highly visible display can be performed.

The control circuit 281 generates the light reception control signal so as to sequentially enable the light receiving elements 261 to 266 in a time division manner in synchronization with a drive timing of each of the light projecting elements 161 to 166. In addition, the control circuit 281 generates the display control signal so as to turn on or off the indicator lamp light source 270 in any light emission color. Further, the control circuit 281 exchanges various types of information with the communication circuit 282, the output circuit 283, and the input circuit 284.

In addition, the control circuit 281 monitors a light incident state or a light shielding state of each of the plurality of optical axes Oax1 to Oax6. For example, the control circuit 281 may output an operation permission signal (ON signal) when all of the plurality of optical axes Oax1 to Oax6 are in the light incident state. On the other hand, the control circuit 281 may output an operation non-permission signal (OFF signal) when at least one of the plurality of optical axes Oax1 to Oax6 is in the light shielding state.

Further, the control circuit 281 may have a function of self-diagnosing whether or not the light incident state or light shielding state of each of the plurality of optical axes Oax1 to Oax6 can be correctly monitored. Note that, as the self-diagnosis method, for example, the control circuit 281 and the output circuit 283 (for example, an output signal switching device [OSSD] output) may be multiplexed, and matching or mismatching of multiplexed signals may be determined.

For example, when the multiplexed signals are matched with each other, OK diagnosis (=a diagnosis result indicating that the state can be correctly monitored) is made. On the other hand, when the multiplexed signals are not matched with each other, NG diagnosis (=a diagnosis result indicating that the state cannot be correctly monitored) is made. Note that, in a case where the NG diagnosis is made, the operation non-permission signal (OFF signal) may be output regardless of the light incident state of each of the plurality of optical axes Oax1 to Oax6.

Note that, information that can be used for safety control is safety information, and general information that cannot be used for safety control is unsafety information. For example, the OSSD output is one piece of safety information. The signal used for the turned-on or turned-off control of each of the indicator lamp light sources 170 and 270 may be a signal indicating the safety information or a signal indicating the unsafety information.

The communication circuit 282 performs wired or wireless communication with the light projector 100 (in particular, the communication circuit 182). For example, the communication circuit 282 receives an input of the information regarding the operation state (an optical-axis detection state, a self-diagnosis result, and the like) of the light curtain 1 from the control circuit 281 and transmits the information to the light projector 100.

The output circuit 283 performs wired or wireless communication with an external machine (for example, a safety controller). For example, the output circuit 283 receives an input of the operation state (an optical-axis detection state, a self-diagnosis result, or the like) of the light curtain 1 from the control circuit 281 and transmits the information to an external machine.

The input circuit 284 performs wired or wireless communication with an external machine (for example, a safety controller). For example, the input circuit 284 receives an input of a work instruction regarding putting in and taking out an object from an external machine and transmits the work instruction to the control circuit 281.

### First Embodiment

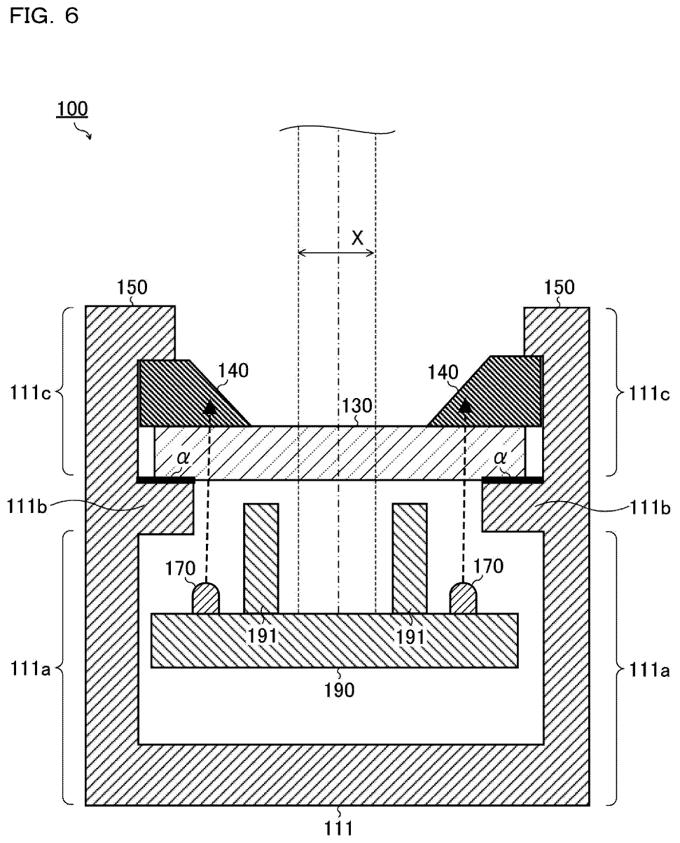

FIG. 6 is a diagram (=a schematic sectional view when a metal case 111 of a light projector 100 is cut at any position in a longitudinal direction) illustrating a first embodiment of the light projector 100. The light projector 100 of the present embodiment includes a housing 110 (only a metal case 111 is depicted in this drawing), a front cover 130, indicator lamps 140, bumpers 150, an indicator lamp light source 170, a substrate 190, and a light shielding plate 191.

The metal case 111 is an extrusion-molded product extending in the longitudinal direction of the light projector 100. With reference to this drawing, the metal case 111 includes a body 111a, a pair of first protruding stripes 111b, and a pair of second protruding stripes 111c.

The body 111a is a hollow member having a U-shaped section with an opening on an upper side of the drawing (=a front side of the light projector 100). The indicator lamp light source 170, the substrate 190, and the light shielding plate 191 are accommodated in an internal space of the body 111a.

The pair of first protruding stripes 111b protrudes from inner side surfaces of left side wall and right side wall of the body 111a toward an inside of the opening. That is, the pair of first protruding stripes 111b is arranged so as to face each other with a predetermined interval, sandwiching an optical-axis crossing region X (=a region crossing a plurality of optical axes Oax1 to Oax6). Note that, the pair of first protruding stripes 111b functions as cover attachment portions for supporting the front cover 130. As described above, a light-transmissive member is used for the front cover 130 as long as the light-transmissive member is provided at least in the optical-axis crossing region X and the optical axes Oax1 to Oax6 are not hindered. For example, in the present embodiment, a portion coming into contact with the pair of first protruding stripes 111b does not necessarily have light-transmissive properties.

The pair of second protruding stripes 111c extends further upward in the drawing from upper ends of the left side wall and the right side wall of the body 111a. In addition, each of the pair of second protruding stripes 111c has a distal end bent toward the inside of the opening. Note that, the pair of second protruding stripes 111c functions as the bumpers 150 for protecting the front cover 130. That is, in the present embodiment, the bumpers 150 described above are formed from the metal case 111. Accordingly, the fastness of the light projector 100 can be enhanced.

The front cover 130 is supported (suspended) at both ends across the pair of first protruding stripes 111b. The front cover 130 causes light beams forming the plurality of optical axes Oax1 to Oax6 to pass in the optical-axis crossing region X. Processing of improving liquid resistance is performed between the front cover 130 and the pair of first protruding stripes 111b (see a thick line a). For example, processing of arranging a packing and bonding with a liquid-resistant adhesive is performed. As described later, since bonding properties between the front cover 130 and the first protruding stripes 111b are enhanced by the indicator lamps 140, liquid resistance is further improved.

The indicator lamps 140 are arranged on both sides of the front cover 130 to be adjacent to the bumpers 150. With reference to this drawing, the indicator lamps 140 are arranged along the longitudinal direction of the light projector 100 in regions sandwiched between the first protruding stripes 111b and the distal ends (bent portions) of the second protruding stripes 111c, that is, in regions sandwiched between the bumpers 150 and the front cover 130.

Note that, the indicator lamp 140 diffuses light incident from the indicator lamp light source 170 via the front cover 130 in various directions. For example, the indicator lamp 140 may have a taper for refracting and diffusing the light incident from the indicator lamp light source 170 toward the inside of the opening.

With the indicator lamps 140 arranged in this manner, it is easy to see even from a side of the light projector 100. Accordingly, in the small-sized (small-diameter) light curtain 1 using the metal case 111, it is possible to perform highly visible display without impairing the rigidity of the housing 110. In particular, in a case where the pair of bumpers 150 is provided so as to protrude from both sides of the front cover 130, an effect of improving the visibility by the above arrangement can be more remarkable.

In addition, in the light projector 100 of the present embodiment, the indicator lamps 140 also function as pressing members for pressing and fixing the front cover 130 downward (=in a direction toward the first protruding stripes 111b). Accordingly, since the bonding properties between the front cover 130 and the first protruding stripe 111b are enhanced, liquid resistance can be improved by preventing liquid from entering the inside of the metal case 111. Note that, in order for the indicator lamps 140 to have the function as the pressing members, it is desirable that the indicator lamps 140 have appropriate elasticity.

The indicator lamp light source 170 is mounted on a main surface (=a surface facing the front cover 130) of the substrate 190. The indicator lamp light source 170 supplies light for display toward the indicator lamps 140 via the front cover 130. With reference to this drawing, the light emitted from the indicator lamp light source 170 passes between the pair of first protruding stripes 111b without being shielded by the pair of first protruding stripes 111b, and is supplied to the indicator lamps 140 via the front cover 130.

Note that, the number of indicator lamp light sources 170 is not limited. For example, a plurality of indicator lamp light sources 170 may be intermittently arranged or may be formed in series along the longitudinal direction of the light projector 100.

In addition, the indicator lamp light source 170 may include a lens for controlling a direction of the emitted light. For example, a lens that is optically designed so as to reduce a spread angle of light in a left-right direction in this drawing and to increase the spread angle of light in a depth direction in this drawing may be provided. According to such a lens, it is possible to reduce the number of indicator lamp light sources 170 while suppressing interference with the plurality of optical axes Oax1 to Oax6.

Note that, a type of the lens may be a point symmetrical lens (single lens arrangement) or a cylindrical lens (series arrangement by extrusion-molded product).

The light shielding plate 191 is provided between the indicator lamp light source 170 and the optical-axis crossing region X. Accordingly, since the light from the indicator lamp light source 170 toward the optical-axis crossing region X is shielded, the light emitted from the indicator lamp light source 170 is less likely to interfere with the plurality of optical axes Oax1 to Oax6.

In addition, a case where the optical axes Oax1 to Oax6 are formed by infrared light, and visible light (red light, green light, orange light, or the like) is emitted from the indicator lamp light source 170 is considered. In this case, a filter that transmits infrared light and shields visible light may be provided in the light receiver 200. In particular, in a case where the indicator lamps 240 are provided in the light receiver 200, a filter that transmits infrared light and shields visible light may be arranged so as not to shield the display of the indicator lamps 240. Filters may be provided in the light receiving elements 261 to 266, or a filter may be provided in a lens that guides light to the light receiving elements 261 to 266.

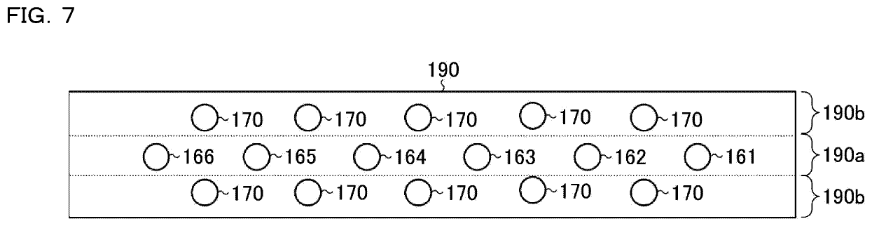

FIG. 7 is a diagram illustrating an arrangement example of the indicator lamp light sources 170 according to the first embodiment. As illustrated in this drawing, the light projecting elements 161 to 166 may be arranged at equal intervals along a longitudinal direction of the substrate 190 in a central region 190a of the substrate 190. On the other hand, the indicator lamp light sources 170 may be arranged at equal intervals along the longitudinal direction of the substrate 190 in an end region 190b of the substrate 190.

In particular, the light projecting elements 161 to 166 and the indicator lamp light sources 170 may be arranged such that positions in the longitudinal direction of the substrate 190 are shifted from each other (staggered). According to such an arrangement example, mutual interference between the light projecting elements 161 to 166 and the indicator lamp light sources 170 is suppressed.

Note that, the number and arrangement of the indicator lamp light sources 170 are not limited to the arrangement example in this drawing. For example, the number of indicator lamp light sources 170 can be reduced such that the light beams supplied to the indicator lamps 140 have some unevenness.

### <Function Expansion>

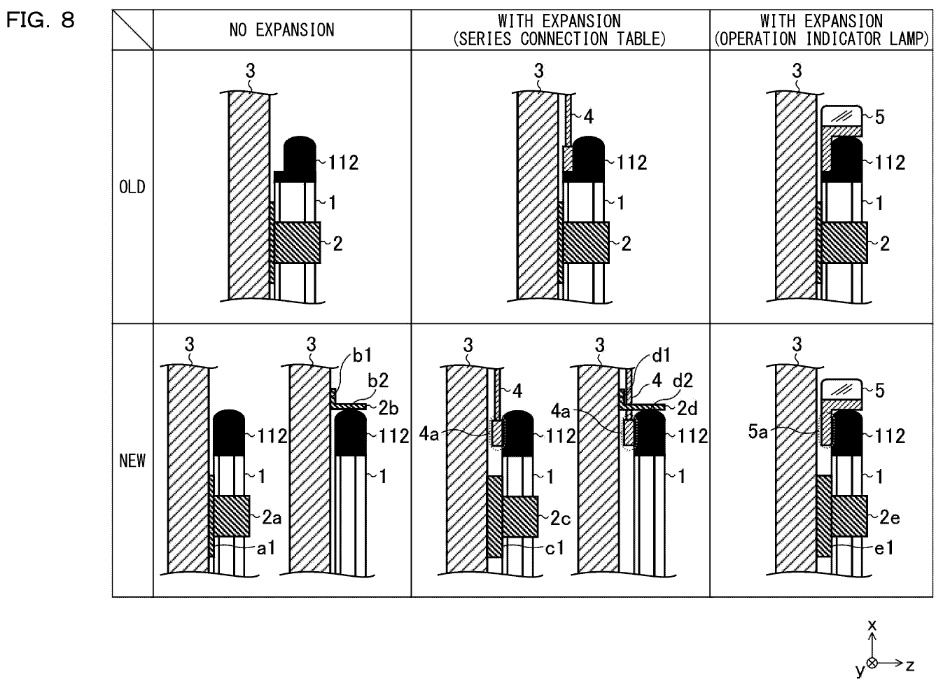

FIG. 8 is an old and new comparison diagram illustrating a relationship between presence or absence of function expansion in the light curtain 1 and the attachment tool. In an upper part of this drawing, an old configuration of the light curtain 1 is depicted. On the other hand, a new configuration of the light curtain 1 is depicted in a lower part of this drawing. In this drawing, the longitudinal direction of the light curtain 1 is an x-axis, a lateral direction is a y-axis, and a thickness direction (depth direction) is a z-axis.

The light curtain 1 in this drawing can be understood as the light projector 100 described above. However, in the following description, the light curtain 1 of this drawing can be understood as the light receiver 200 by reading reference numerals in 100 series as reference numerals in 200 series.

Note that, in each of the upper part and the lower part of this drawing, a left field represents a case where there is no function expansion, a center field represents a case where a series connection cable 4 is connected, and a right field represents a case where the operation indicator lamp 5 is connected. Each of the series connection cable 4 and the operation indicator lamp 5 is attached to the end cap 112 of the light curtain 1, and can be understood as a function expansion unit that expands a function of the light curtain 1. The series connection cable 4 is used to connect the light curtain 1 and another light curtain in series. The operation indicator lamp 5 is used to display an operation state of the light curtain 1. As described above, a multiple-optical-axis photoelectric sensor having function expandability is constructed by the light curtain 1 and various function expansion units attached to and detached from the light curtain 1.

Each of attachment tools 2 and 2a to 2e corresponds to a jig for attaching the light curtain 1 to a base 3. That is, a multiple-optical-axis photoelectric sensor including the attachment tools 2 and 2a to 2e and the light curtain 1 attached to the attachment tools 2 and 2a to 2e can be installed on the base 3.

Incidentally, as illustrated in the upper part of this drawing, the light curtain 1 having the old configuration is attached to the base 3 with the common attachment tool 2 without depending on whether or not the series connection cable 4 and the operation indicator lamp 5 are connected. The attachment tool 2 is designed such that a gap generated between the light curtain 1 and the base 3 is minimized. Thus, the light curtain 1 having the old configuration is designed such that the series connection cable 4 and the operation indicator lamp 5 do not protrude from an outer peripheral surface facing the base 3, for example, a rear surface. With reference to this drawing, a surplus space is secured on a rear surface of the end cap 112 by a thickness of the series connection cable 4 or the operation indicator lamp 5. Accordingly, in the light curtain 1 having the old configuration, there is a limit to size reduction of the housing 110.

On the other hand, as illustrated in the lower part of this drawing, the light curtain 1 having the new configuration is designed such that the thicknesses of the series connection cable 4 and the operation indicator lamp 5 that can be connected at the time of function expansion are ignored and the size of the housing 110 is minimized on the assumption that the light curtain 1 is used alone. When turned back, the light curtain 1 having the new configuration is designed to allow the series connection cable 4 and the operation indicator lamp 5 to protrude from a rear surface of the light curtain 1 at the time of function expansion.

For example, the series connection cable 4 and the operation indicator lamp 5 have protrusions 4a and 5a, respectively. Each of the protrusions 4a and 5a extends along the longitudinal direction of the light curtain 1 and is attached to the end cap 112 of the light curtain 1 so as to protrude from the rear surface of the light curtain toward the base 3.

As a result, in the light curtain 1 having the new configuration, a size of the gap generated between the light curtain 1 and the base 3 changes depending on the presence or absence of function expansion. Therefore, as a jig for attaching the light curtain 1 having the new configuration to the base 3, a plurality of types of attachment tools 2a to 2e may be prepared depending on the presence or absence of function expansion.

The attachment tool 2a has a base portion al. For example, the base portion al has a rear surface attached to the base 3, and the base portion al receives the housing 110 of the light curtain 1 from a front side. The attachment tool 2a is used when the light curtain 1 is used alone. Accordingly, the attachment tool 2a can be formed such that a gap is not generated between the light curtain 1 and the base 3 as much as possible, similarly to the attachment tool 2 described above. Specifically, a thickness of the base portion al interposed between the light curtain 1 and the base 3 may be designed to be the minimum necessary.

The attachment tool 2b is an L-shaped angle having main surfaces b1 and b2. The main surface b1 may be an xy plane attached to the base 3. The main surface b2 may be a yz plane attached to an end face of the end cap 112 in the longitudinal direction of the light curtain 1. The attachment tool 2a is used when the light curtain 1 is used alone. Thus, like the attachment tool 2 described above, the attachment tool 2a can be formed such that a gap is not generated between the light curtain 1 and the base 3 as much as possible. Specifically, a length of the main surface b2 in a z-axis direction may be designed in accordance with the thickness of the light curtain 1 in the z-axis direction.

As described above, when the light curtain 1 is used alone, the attachment tools 2a and 2b having a smaller size in the thickness direction than the attachment tools 2c to 2e described later can be used. Accordingly, it is possible to attach the multiple-optical-axis photoelectric sensor as a whole in a space-saving manner by reducing the size of the light curtain 1 and each of the attachment tools 2a and 2b.

The attachment tool 2c has a base portion c1. For example, the base portion c1 has a rear surface attached to the base 3 and receives the housing 110 of the light curtain 1 from a front side. The attachment tool 2c is used when the series connection cable 4 is connected. Accordingly, the attachment tool 2c can be configured to form an accommodation space of the protrusion 4a between the rear surface of the light curtain 1 and the base 3. Specifically, a thickness of the base portion c1 may be designed such that a distance from the rear surface of the light curtain 1 to the rear surface of the base portion c1 is larger than a thickness of the protrusion 4a.

The attachment tool 2d is an L-shaped angle having main surfaces d1 and d2. The main surface d1 may be an xy plane attached to the base 3. The main surface d2 may be a yz plane attached to the end face of the end cap 112 in the longitudinal direction of the light curtain 1. The attachment tool 2d is used when the series connection cable 4 is connected. Accordingly, the attachment tool 2d can be configured to form the accommodation space of the protrusion 4a between the rear surface of the light curtain 1 and the base 3. Specifically, a length of the main surface b2 in the z-axis direction may be designed such that a distance from the rear surface of the light curtain 1 to the main surface d1 is larger than the thickness of the protrusion 4a.

The attachment tool 2e has a base portion e1. The base portion e1, for example, has a rear surface attached to the base 3 and receives the housing 110 of the light curtain 1 from a front side. The attachment tool 2e is used when the operation indicator lamp 5 is connected. Accordingly, the attachment tool 2e can be configured to form an accommodation space of the protrusion 5a between the rear surface of the light curtain 1 and the base 3. Specifically, a thickness of the base portion e1 may be designed such that a distance from the rear surface of the light curtain 1 to a rear surface of the base portion e1 is larger than a thickness of the protrusion 5a.

As described above, the attachment tools 2c to 2e capable of absorbing the thickness of each of the protrusions 4a and 5a can be used when the function of the light curtain 1 is expanded. Accordingly, even though the protrusions 4a and 5a protrude from the rear surface of the light curtain 1 toward the base 3, it is less likely to interfere with a work of attaching the light curtain 1.

Note that, this drawing is merely an example. According to this drawing, it is possible to flexibly respond to a wide variety of user needs by developing a group of products including a plurality of types of attachment tools in addition to the light curtain and various function expansion units attached to or detached from the light curtain.

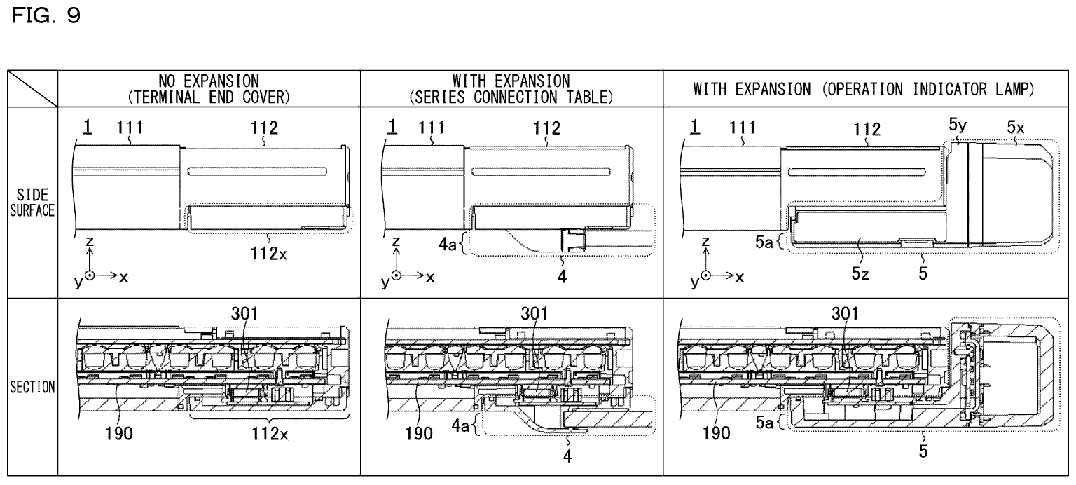

FIG. 9 is a diagram illustrating a relationship between the presence or absence of function expansion in the light curtain 1 and a size in the thickness direction (depth direction). In an upper part of this drawing, a side surface of the light curtain 1 is depicted. On the other hand, in a lower part of this drawing, a section when the light curtain 1 is cut perpendicularly to the y-axis, that is, a zx section is depicted.

The light curtain 1 includes the metal case 111, the end cap 112, and the substrate 190. The metal case 111 can be understood as a body of the light curtain 1 forming the plurality of optical axes along the longitudinal direction. The end cap 112 can be understood as an end member fixed to one end of the metal case 111. The substrate 190 is provided from the metal case 111 to the end cap 112. The optical elements forming the plurality of optical axes and the control circuit thereof are mounted on the substrate 190. The plurality of optical elements are arranged on the substrate 190 at predetermined intervals along the longitudinal direction. The plurality of optical axes are formed not only in the metal case 111 but also in the end cap 112. The substrate 190 may be divided into a plurality of parts along the longitudinal direction.

As illustrated in a center field and a right field of this drawing, the series connection cable 4 and the operation indicator lamp 5 are attached to the rear surface of the end cap 112 in a direction orthogonal to the longitudinal direction of the light curtain 1, that is, in the z-axis direction. At this time, the protrusions 4a and 5a protrude from the rear surface of the light curtain 1. Electric components, electric wires, substrates, and the like can be accommodated in the protrusions 4a and 5a.

The operation indicator lamp 5 includes, for example, a light emitting portion 5x, a bottom portion 5y, and a connecting portion 52. The light emitting portion 5x emits light to display the operating state of the light curtain 1. The light emitting portion 5x may have a dome shape. The bottom portion 5y abuts on the end face of the end cap 112 in the longitudinal direction of the light curtain 1 to carry the light emitting portion 5x. The bottom portion 5y may be fastened to the end cap 112 with a screw or the like. Thus, dustproof and waterproof performance of the light curtain 1 is enhanced. The connecting portion 52 extends from the bottom portion 5y to the rear surface of the end cap 112 along the longitudinal direction of the light curtain 1.

On the other hand, as illustrated in a left field of this drawing, when the function expansion units such as the series connection cable 4 and the operation indicator lamp 5 are not attached, that is, when the light curtain 1 is used alone, a terminal end cover 112x is attached to the rear surface of the end cap 112. The terminal end cover 112x can be formed so as not to protrude from the rear surface of the light curtain 1 but to be flush with the rear surface of the light curtain 1.

The terminal end cover 112x, the series connection cable 4, and the operation indicator lamp 5 are directly connected to the substrate 190 via a connector 301 provided in the light curtain 1. With this configuration, the size of the housing 110 can be reduced as compared with the configuration of the related art separately including a sub-substrate for function expansion.

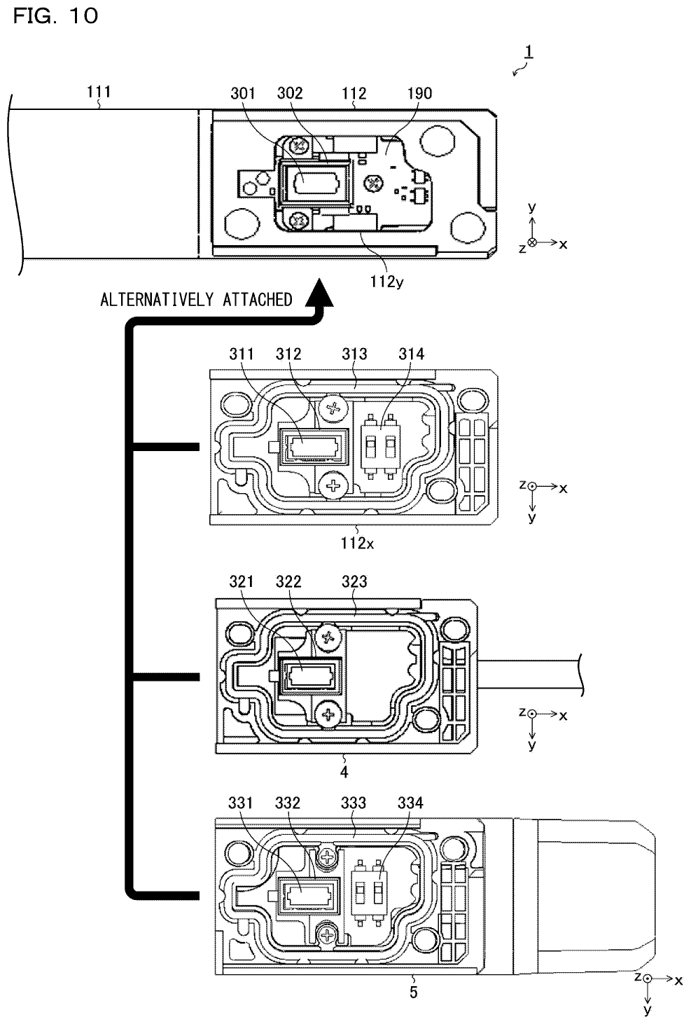

FIG. 10 is a diagram illustrating an attachment mechanism of the end cap 112. The rear surface of the light curtain 1 is depicted in an uppermost part of this drawing. In three lower parts of this drawing, an attachment surface of each of the terminal end cover 112x, the series connection cable 4, and the operation indicator lamp 5, that is, a surface facing the end cap 112 at the time of attachment to the light curtain 1 is depicted.

The light curtain 1 has the connector 301. The connector 301 is mounted on the substrate 190 extending to the end cap 112. The connector 301 may be arranged on a side opposite to a light projecting direction or a light receiving direction of the optical element with respect to the substrate 190, that is, on a rear surface side of the end cap 112.

The end cap 112 has an opening 112y that exposes the connector 301 on the rear surface side. Accordingly, various function expansion units are attachable to or detachable from the connector 301 in a direction orthogonal to the longitudinal direction of the light curtain 1, that is, in the z-axis direction. For example, any one of the terminal end cover 112x, the series connection cable 4, and the operation indicator lamp 5 can be alternatively attached to the connector 301.

The terminal end cover 112x is attached to the connector 301 when both the series connection cable 4 and the operation indicator lamp 5 are not attached. The terminal end cover 112x can be understood as a lid member for covering the opening 112y of the end cap 112 when the light curtain 1 is used alone. However, the terminal end cover 112x is not a simple lid member, and also has a function of causing the light curtain 1 to recognize that the terminal end cover itself is a terminal end.

The terminal end cover 112x, the series connection cable 4, and the operation indicator lamp 5 have connectors 311, 321, and 331 attachable to or detachable from the connector 301, respectively. When the terminal end cover 112x is attached to the end cap 112, the connector 301 and the connector 311 are coupled. When the series connection cable 4 is attached to the end cap 112, the connector 301 and the connector 321 are coupled. When the operation indicator lamp 5 is attached to the end cap 112, the connector 301 and the connector 331 are coupled.

In addition, the light curtain 1 has a guide portion 302. The guide portion 302 guides each of the connectors 311, 321, and 331 to a coupling position with the connector 301. The guide portion 302 may be a rectangular frame-shaped member surrounding the connector 301. The guide portion 302 may be designed such that a height in the z-axis direction is slightly larger than the connector 301.

For example, when the terminal end cover 112x is attached to the end cap 112, first, the terminal end cover 112x is positioned with respect to the end cap 112 by the guidance of the guide portion 302, and thereafter, the connector 301 and the connector 311 are coupled.

The same applies to a case where the series connection cable 4 or the operation indicator lamp 5 is attached to the end cap 112. That is, after the series connection cable 4 or the operation indicator lamp 5 is positioned with respect to the end cap 112, the connector 301 and the connector 321 or 331 are coupled.

With this configuration, it is difficult for the connectors to come into contact with each other in a state where relative positions are shifted. Accordingly, breakage of the connector 301 and each of the connectors 311, 321, and 331 can be prevented.

Each of the terminal end cover 112x, the series connection cable 4, and the operation indicator lamp 5 may be fastened to the end cap 112 with a screw or the like. With this configuration, the dustproof and waterproof performance of the light curtain 1 can be enhanced.

The guide portion 302 may be fixed to the end cap 112 without abutting on the substrate 190. With this configuration, a load applied to the substrate 190 is reduced when the connector 301 and the connector 311, 321, or 331 are coupled. Accordingly, since the substrate 190 is less likely to be deformed, the influence on the optical axis is reduced.

The terminal end cover 112x may include a guide portion 312 that guides the connector 311 to the coupling position with the connector 301. The series connection cable 4 may include a guide portion 322 that guides the connector 321 to the coupling position with the connector 301. The operation indicator lamp 5 may include a guide portion 332 that guides the connector 331 to the coupling position with the connector 301. With this configuration, breakage due to erroneous contact between the connectors can be prevented. However, when the guide portion 302 is provided in the light curtain 1, the guide portions 312, 322, and 332 are not essential.

The terminal end cover 112x, the series connection cable 4, and the operation indicator lamp 5 have packings 313, 323, and 333, respectively. When the terminal end cover 112x is attached to the end cap 112, a periphery of the opening 112y is sealed by the packing 313. When the series connection cable 4 is attached to the end cap 112, the periphery of the opening 112y is scaled by the packing 323. When the operation indicator lamp 5 is attached to the end cap 112, the periphery of the opening 112y is sealed by the packing 333.

The terminal end cover 112x and the operation indicator lamp 5 include dip switches 314 and 334, respectively. The dip switches 314 and 334 may be used as interference prevention setting switches. For example, “00 (interference prevention setting off)”, “01 (setting A)”, and “10 (setting B)” can be set by using the 2-bit 4-value dip switches 314 and 334. Such interference prevention setting is performed, and thus, for example, erroneous synchronization or malfunction between adjacent light curtains can be prevented.

### <Cable Connection>

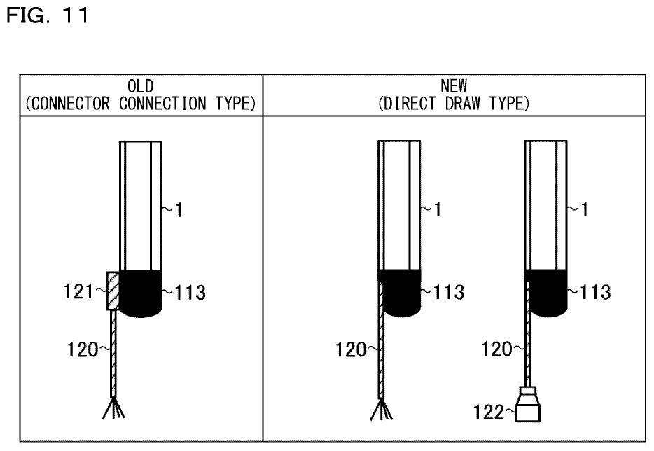

FIG. 11 is an old and new comparison diagram of a cable connection structure in the light curtain 1. In a left field of this drawing, an old structure (connector-connected type) is depicted. In a right field of this drawing, a new structure (direct draw type) is depicted. As illustrated in this drawing, the cable 120 is connected to the end cap 113 of the light curtain 1. The end cap 113 is provided at an end of both ends of the light curtain 1, which is opposite to the end cap 112 to or from which the series connection cable 4, the operation indicator lamp 5, or the like can be attached or detached.

In the old structure, the cable 120 is attachable to or detachable from the end cap 113 via a connector 121. Accordingly, the number of pins of the cable 120 and the like can be voluntarily changed in accordance with the user's needs. However, in the old structure, the connector 121 protrudes from the rear surface of the light curtain 1. Thus, attachment in a space-saving manner can be hindered. For example, with reference to FIG. 8 described above, when the light curtain 1 is used alone, it is possible to be difficult to attach the light curtain 1 to the base 3 by the attachment tools 2a and 2b.

In view of the above consideration, in the new structure, the cable 120 is drawn out directly from the end cap 113 along the longitudinal direction of the light curtain 1 without protruding from an outer peripheral surface of the light curtain 1. Thus, attachment in a space-saving manner is facilitated.

Note that, the cable 120 may be a so-called pigtail. That is, the cable 120 may include a connector 122 at a tail end. The connector 122 may be a highly versatile M12 connector. With this configuration, the number of pins of a cable (not illustrated) to be attached to or detached from a tip of the connector 122 can be voluntarily changed in accordance with the user's needs. In addition, for example, a function and an operation of the light curtain 1, for example, validity or invalidity of a communication function may be switched in accordance with the number of pins of the cable to be attached to or detached from the connector 122.

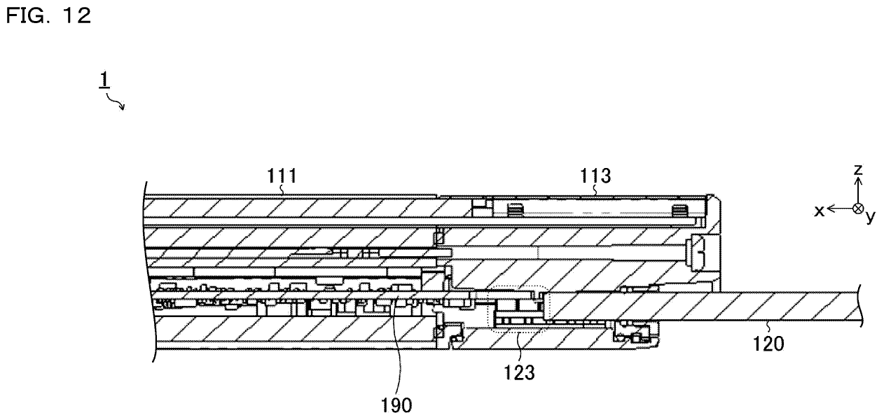

FIG. 12 is a sectional view illustrating a cable connection example of the new structure (direct draw type). In particular, this drawing can be understood as a section when the light curtain 1 is cut perpendicularly to the y-axis, that is, the zx section.

As illustrated in this drawing, the cable 120 may be directly connected to the substrate 190 by a pressure contact connector 123. In addition, the cable 120 and the substrate 190 may be directly connected by soldering.

### <End Cap Fixing>

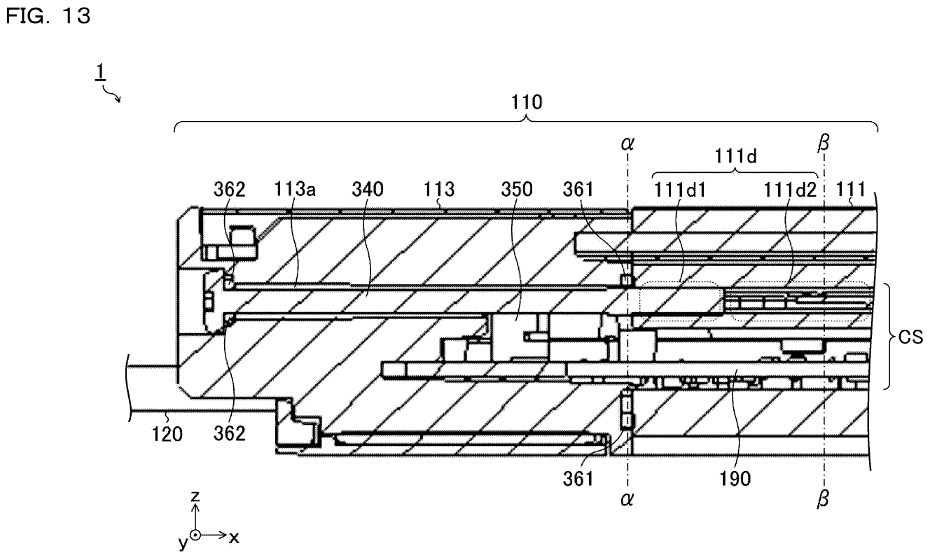

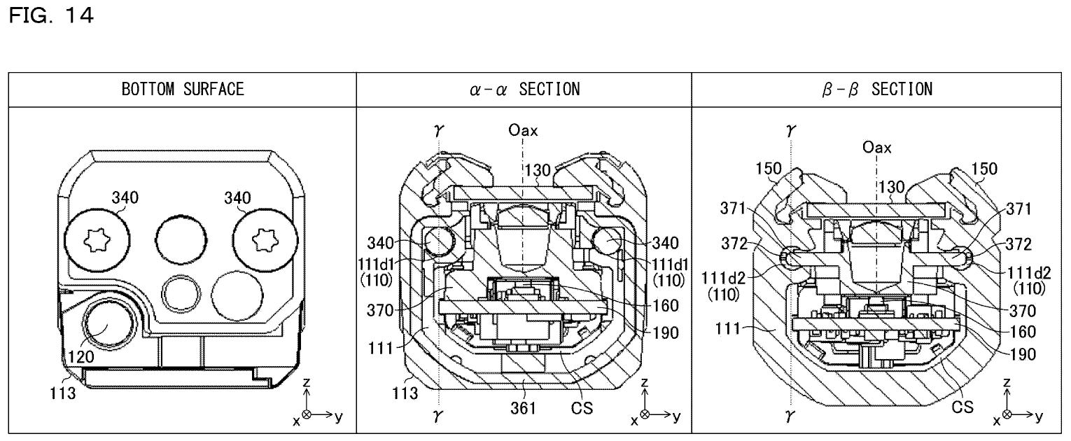

Next, a method for fixing the end cap 113 is proposed with reference to FIGS. 13 and 14. FIG. 13 is a sectional view illustrating an example of a fixing structure between the metal case 111 and the end cap 113. FIG. 13 can be understood as a zx section when the light curtain 1 is cut perpendicularly to the y-axis, specifically, a γ-γ section in FIG. 14. FIG. 14 is a diagram illustrating a bottom surface of the light curtain 1, and an α-α section and a β-β section of FIG. 13.

The light curtain 1 includes the housing 110, the front cover 130, the substrate 190, a screw 340, an AC discharge unit 350, and packings 361 and 362. The housing 110 includes the metal case 111 and the end cap 113.

The metal case 111 is a hollow member extending along the longitudinal direction of the light curtain 1. A surface of the metal case 111 is subjected to insulation treatment such as coating and alumite treatment.

Light projecting elements 160 forming a plurality of optical axes Oax along the longitudinal direction of the light curtain 1 are arranged inside the metal case 111. The light projecting elements 160 can be understood as, for example, optical elements corresponding to the light projecting elements 161 to 166 described above.

A part of the metal case 111 may function as the bumper 150. The bumper 150 may protrude from the outer surface of the front cover 130 along the plurality of optical axes Oax. With this configuration, the fastness of the light curtain 1 is enhanced.

Screw holes 111d that receive a distal end of the screw 340 are formed in the metal case 111. The screw holes 111d may be formed as through-holes extending from one end face to the other end face of the metal case 111 along the longitudinal direction of the light curtain 1. The screw hole 111d has a first region 111d1 and a second region 111d2. A pair of screw holes 111d may be provided with the optical axes Oax interposed therebetween as illustrated in an α-α section and a β-β section of FIG. 14.

The first region 111d1 can be understood as a region of the screw hole 111d close to the end face of the metal case 111, specifically, a region close to a surface facing the end cap 113. The first region 111d1 may have a screw groove that meshes with a screw thread engraved on the distal end of the screw 340. The first region 111d1 is not subjected to insulation treatment such as coating and alumite treatment. Accordingly, the metal case 111 can establish electrical conduction with the screw 340 in the first region 111d1 of the screw hole 111d.

The second region 111d2 can be understood as a region of the screw hole 111d excluding the first region 111d1. The second region 111d2 may be opened to face the substrate 190 and function as a locking groove that supports locking projections 371 of the holder 370 that support the substrate 190. That is, a pair of locking grooves may be provided in the metal case 111 with the holder 370 interposed therebetween.

The holder 370 has the pair of locking projections 371. Each of the pair of locking projections 371 is fitted into and supported by the locking grooves provided in the metal case 111, that is, the second region 111d2 of the screw hole 111d.

The pair of locking projections 371 may have position adjustment mechanisms 372, respectively. Each of the pair of position adjustment mechanisms 372 may be an elastic member that presses an inner wall of the locking groove provided in the metal case 111, that is, an inner wall of the second region 111d2 in a y-axis direction and the z-axis direction. With this configuration, a relative position of the substrate 190 in the y-axis direction and a relative position thereof in the z-axis direction with respect to the metal case 111 can be adjusted.

The end cap 113 can be understood as an end member fixed to one end of the metal case 111. A through-hole 113a through which the screw 340 passes is formed in the end cap 113. The through-hole 113a extends from one end face to the other end face of the end cap 113 along the longitudinal direction of the light curtain 1. In addition, the cable 120 may be connected to the end cap 113.

The front cover 130 is attached to a front surface of the housing 110 so as to transmit light beams from the light projecting elements 160 and cross the plurality of optical axes Oax.

The substrate 190 is arranged in a sealed space CS formed by the housing 110 and the front cover 130. The light projecting elements 160 and the AC discharge unit 350 are mounted on the substrate 190.

The screw 340 can be understood as a fixing member that fixes the end cap 113 to the metal case 111. The end cap 113 may be fixed to the metal case 111 with a pair of screws 340 inserted from a bottom surface side. The screw 340 may be a conductive fixing member electrically conducted to the metal case 111.

The AC discharge unit 350 performs capacitor coupling between the metal case 111 and a ground wire 192 of the substrate 190 via the conductive screw 340. Accordingly, the noise resistance of the light curtain 1 is enhanced. Note that, the AC discharge unit 350 will be described in detail later.

The packing 361 is sandwiched between the metal case 111 and the end cap 113 to prevent dust and liquid from entering the sealed space CS from the outside. The screw 340 may be provided inside the packing 361, that is, in the sealed space CS.

The packing 362 is sandwiched between a seat surface of the screw 340 and the end cap 113 to prevent dust and liquid from entering the sealed space CS from the outside.

### <AC Discharge Unit>

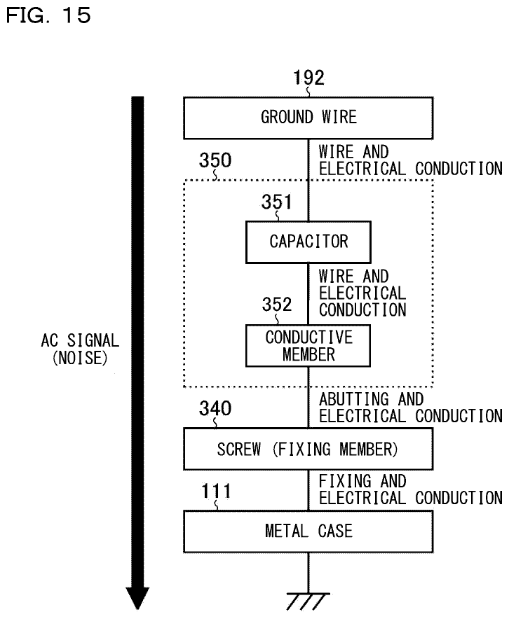

FIG. 15 is a diagram illustrating a configuration example of the AC discharge unit 350. The AC discharge unit 350 of the present configuration example includes a capacitor 351 and a conductive member 352.

The capacitor 351 is mounted on the substrate 190. A first end of the capacitor 351 is conducted to the ground wire 192 laid on the substrate 190. A second end of the capacitor 351 is electrically conducted to the conductive member 352 via a wiring laid on the substrate.

The conductive member 352 conduct between the second end of the capacitor 351 and the screw 340 by abutting on the screw 340. Note that, the conductive member 352 will be described in detail later.

The screw 340 is electrically conducted with the metal case 111 as described above. More specifically, the screw 340 is made of metal, for example, and is electrically conducted to the metal case 111 by being fastened to the screw hole 111d not subjected to the insulation treatment. The metal case 111 can be understood as earth.

The series of electrical connections achieves capacitor coupling between the metal case 111 and the ground wire 192 via the conductive screw 340. Accordingly, since an AC signal such as noise is discharged from the ground wire 192 to the metal case 111, the noise resistance of the light curtain 1 is enhanced.

In addition, with this configuration, as compared with the configuration of the related art in which electrical conduction is established at a cut end face of the metal case 111, the size of the metal case 111 can be reduced, and stable conduction can be easily secured.

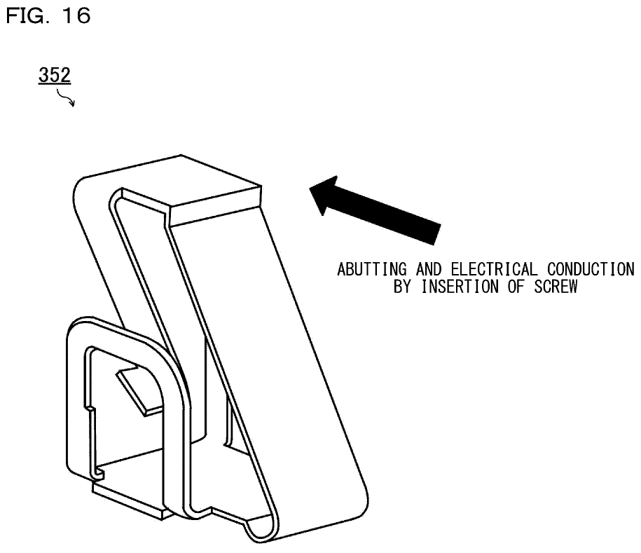

FIG. 16 is a diagram illustrating a configuration example of the conductive member 352. As illustrated in this drawing, the conductive member 352 may be a conductive leaf spring, a so-called shield finger, which abuts on the screw 340 inserted into the through-hole 113a of the end cap 113 in a biased state.

Note that, although not illustrated again, a fixing structure between the metal case 111 and the end cap 112 is basically similar to the above description.

### <Case Outer Shape>

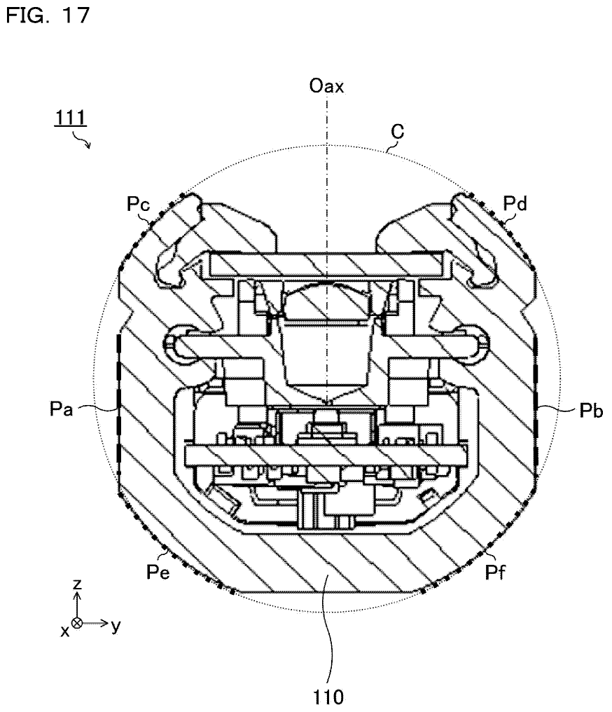

FIG. 17 is a sectional view illustrating an outer shape of the housing 110 (particularly, the metal case 111). Note that, in this drawing, a section when the housing 110 is vertically cut at any position in the longitudinal direction, that is, a zy section orthogonal to the longitudinal direction is drawn. As illustrated in this drawing, the housing 110 includes side wall portions Pa and Pb and arc portions Pc to Pf.

The side wall portions Pa and Pb are substantially parallel to the optical axis Oax in zy sectional view of the housing 110. The side wall portions Pa and Pb are provided so as to be line-symmetric with each other with respect to the optical axis Oax. Each of the arc portions Pc to Pf becomes a part of a circumference C in zy sectional view of the housing 110. The arc portions Pc and Pd are provided so as to be line-symmetric with each other with respect to the optical axis Oax. The arc portions Pe and Pf are provided so as to be line-symmetric with respect to the optical axis Oax. The arc portions Pc and Pd are provided in front of the side wall portions Pa and Pb, that is, on a front surface side of the housing 110. The arc portions Pe and Pf are provided behind the side wall portions Pa and Pb, respectively, that is, on a rear surface side of the housing 110.

The housing 110 of the present configuration example is attached to the attachment tool 2a, 2c, or 2e of FIG. 8 so as to be directly gripped. Accordingly, it is not necessary to form a fitting attachment groove on a rear surface of the housing 110. Note that, in a general configuration in which the fitting attachment groove is formed in the housing 110, it is necessary to increase strength of a rear surface portion where the fitting attachment groove is formed, and the size of the housing 110 is increased. On the other hand, in the housing 110 of the present configuration example, since there is no restriction on the strength of the rear surface portion, the size of the housing 110 can be reduced.

In addition, as described above, the housing 110 of the present configuration example has the arc portions Pc to Pf. Accordingly, a rotational position of the housing 110 can be voluntarily adjusted by rotating the housing 110 about the x-axis in a state where the housing 110 is temporarily fixed to the attachment tools 2a, 2c, or 2e.

### OTHER MODIFICATIONS

Note that, in addition to the embodiments, various modifications can be made to various technical characteristics disclosed in the present specification without departing from the spirit of the technical creation. That is, it is to be understood that the above embodiments are illustrative in all respects and not restrictive, and the technical scope of the invention is defined by the claims, and includes all modifications falling within the meaning and scope equivalent to the claims.

What is claimed is:

1. A multiple-optical-axis photoelectric sensor comprising:
a light curtain that forms a plurality of optical axes along a longitudinal direction; and
a function expansion unit that is attachable to or detachable from a first end of the light curtain and expands a function of the light curtain,
wherein the function expansion unit has a protrusion that extends along the longitudinal direction and is attached to the first end of the light curtain so as to protrude from an outer peripheral surface of the light curtain.

2. The multiple-optical-axis photoelectric sensor according to claim 1, wherein the function expansion unit is attached to the first end of the light curtain from a direction orthogonal to the longitudinal direction.

3. The multiple-optical-axis photoelectric sensor according to claim 1, wherein the function expansion unit is a cable for connecting the light curtain and another light curtain in series, or an operation indicator lamp that displays an operation state of the light curtain.

4. The multiple-optical-axis photoelectric sensor according to claim 1, further comprising a terminal end cover that is attached to the first end of the light curtain when the function expansion unit is not attached, and causes the light curtain to recognize that the terminal end cover itself is a terminal end.

5. The multiple-optical-axis photoelectric sensor according to claim 4, wherein the light curtain includes a first connector to which any one of the terminal end cover and a plurality of types of the function expansion units is alternatively attached, and each of the terminal end cover and the plurality of types of function expansion units includes a second connector attachable to or detachable from the first connector.

6. The multiple-optical-axis photoelectric sensor according to claim 1, further comprising an attachment tool that attaches the light curtain to a base, wherein the protrusion protrudes toward the base, and the attachment tool is configured to form an accommodation space of the protrusion between the outer peripheral surface of the light curtain and the base.

7. The multiple-optical-axis photoelectric sensor according to claim 6, wherein the attachment tool includes a base portion having a rear surface attached to the base and receiving a housing of the light curtain from a front side, and a distance from the outer peripheral surface of the light curtain to the rear surface of the base portion is larger than a thickness of the protrusion.

8. The multiple-optical-axis photoelectric sensor according to claim 6, wherein the attachment tool is an L-shaped angle in which a first main surface is attached to the base and a second main surface is attached to an end face of the light curtain in the longitudinal direction, and a distance from the outer peripheral surface of the light curtain to the first main surface is larger than a thickness of the protrusion.

9. The multiple-optical-axis photoelectric sensor according to claim 1, wherein the light curtain includes a cable directly drawn out along the longitudinal direction from a second end opposite to the first end without protruding from the outer peripheral surface.

10. The multiple-optical-axis photoelectric sensor of claim 9, wherein the cable is a pigtail including a connector at a tail end.
